(19) United States
(12) Patent Application Publication
(10) Pub. No.: US 2011/0064536 A1
(43) Pub. Date: Mar. 17, 2011

(54) Electronic component fixing device

(75) Inventor: Deng-Hsi Chen, Keelung (TW)

(73) Assignee: Lian Li Industrial Co., Ltd.

(21) Appl. No.: 12/007,477

(22) Filed: Jan. 10, 2008

(51) Int. Cl. F16B 1/00

(52) U.S. Cl. 411/84

(57) ABSTRACT

An electronic component fixing device, which includes the restraining piece positioned in a horizontal direction to an electronic component, and at least one antiskid screw positioned in a vertical direction to the electronic component. When installing the electronic component, the restraining piece is assembled to a retaining wall of a computer case, and the antiskid screws are caused to movable penetrate a partition of the computer case, thereby separately restraining the horizontal surface and the perpendicular surface of the electronic component so as to suppress vibration in a horizontal direction and vertical direction of the electronic component when operating, and reduce noise produced by friction or impact with the computer case.

### BACKGROUND OF THE INVENTION

(a) Field of the Invention

The present invention relates to an electronic component fixing device for a computer case, and more particularly to an electronic component fixing device that is used to fixedly secure an electronic component in a horizontal and vertical direction, thereby reducing noise when the electronic component is operating.

(b) Description of the Prior Art

In general, the majority of electronic components assembled to a computer case, including power supplies, CD-ROM (Compact Disc Read-Only Memory) drives, hard disk drives, and the like, are fixed to retaining walls, partitions or supporting frames of the computer case using fixing screws. Because design of the supporting frames adopts a bilateral fixing method, thus, the electronic component can be completely secured, and thereby reduce noise and shaking. However, taking the power supply as an example, and referring to FIG. 1, which shows a schematic view depicting an installation of a power supply of the prior art, and, as depicted in the drawing, when securing the power supply, a plurality of fixing screws 10 are used to penetrate a retaining wall 201 of a rear side of a computer case 20 to fix one side of the power supply to the retaining wall 201, and the power supply 30 is fixed within the computer case 20 by suspension means. However, because of the heavy weight of the power supply 30, and because of the configuration of cooling fans, thus, the power supply 30 is caused to vibrate or even shake when operating, and harassing noise is produced by the portions of the computer case 20 in contact with the power supply 30 because of local friction or impact. Moreover, long-term vibration or shaking can cause damage to the computer case 20 or the power supply 30. Hence, there is a need for improvement.

### SUMMARY OF THE INVENTION

In light of the problem of noise being produced from friction or impact between the electronic component and the computer case caused by vibration of the electronic component when operating, the inventor of the present invention, having accumulated years of experience in related arts, has meticulously carried out extensive study and exploration to ultimately design a new improved electronic component fixing device.

A primary objective of the present invention is to provide the electronic component fixing device that is able to suppress vibration of the electronic component, and thereby achieve reducing noise produced resulting from the vibration.

In order to achieve the aforementioned objective, the electronic component fixing device of the present invention primarily comprises: the restraining piece positioned in a horizontal direction to an electronic component, and at least one antiskid screw positioned in a vertical direction to the electronic component. When installing the electronic component, a side of the electronic component is fixedly secured to a retaining wall of the computer case, and the restraining piece is assembled to the adjacent retaining wall of the computer case, and a locking or restraining method is used to fixedly secure the electronic component between the restraining piece and the retaining walls, thereby suppressing horizontal vibration of the electronic component when operating. Moreover, a plurality of partitions are formed within the computer case, and one of the partitions is mutually parallel with the aforementioned retaining wall used to assemble the restraining piece, and the antiskid screws movably penetrate the partition. Each of the antiskid screws comprises a screw head portion, a threaded portion and an antiskid sleeve. After tightening the antiskid screw, the antiskid sleeve at one end of the antiskid screw is able to vertically restrain the electronic component and thereby suppress vertical vibration of the electronic component when operating. Accordingly, because the horizontal direction and vertical direction of the electronic component has been completely restrained, thus, vibration or shaking of the electronic component is substantially reduced, thereby lowering noise produced by friction or impact with the computer case.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view depicting installation of a power supply of the prior art.

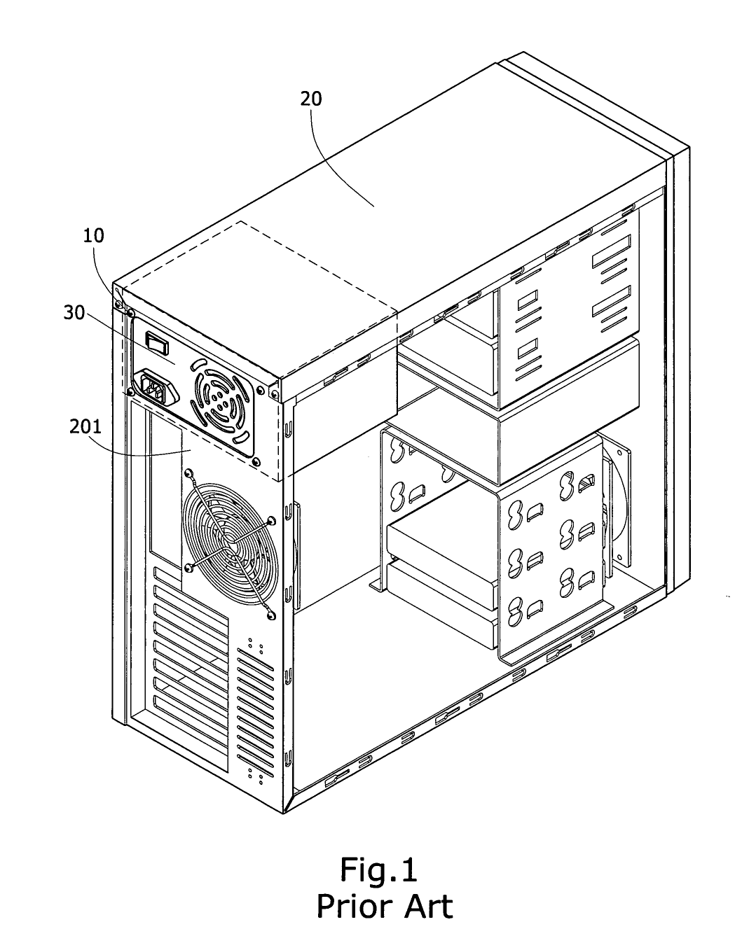

FIG. 2 shows a schematic view depicting installation of a preferred embodiment of the present invention.

FIG. 3 shows an exploded elevational view depicting the preferred embodiment of the present invention.

FIG. 4 shows an assembled cutaway view of the preferred embodiment according to the present invention.

FIG. 5 shows an elevational structural view depicting the restraining piece in the preferred embodiment of the present invention.

FIG. 6 shows an elevational structural view depicting an antiskid screw in the preferred embodiment of the present invention.

### DETAILED DESCRIPTION OF THE PREFERRED EMBODIMENTS

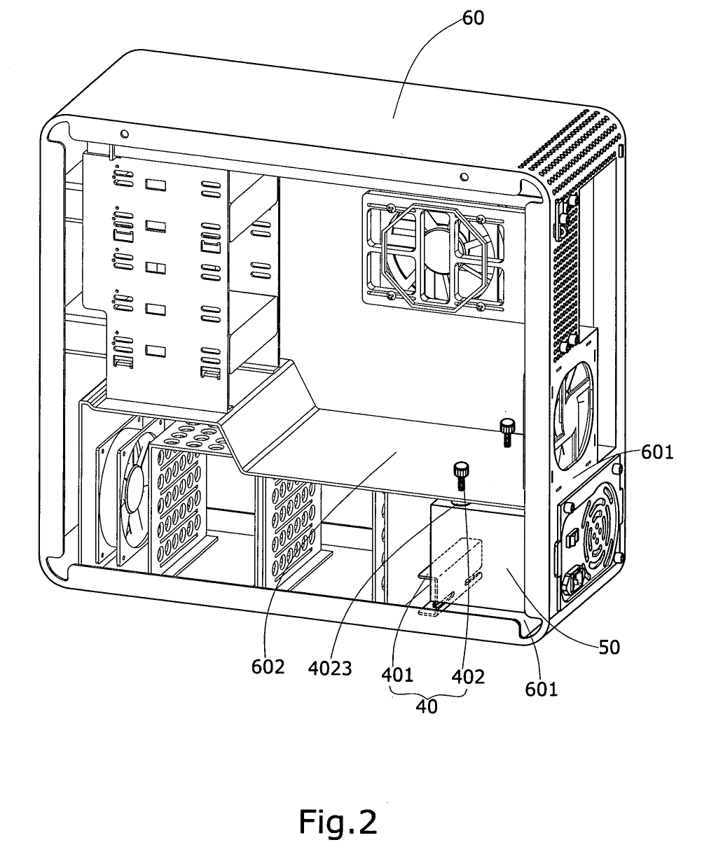

Referring to FIG. 2, which shows a schematic view depicting installation of a preferred embodiment according to the present invention, and, as depicted in the drawing, an electronic component fixing device 40 of the present invention is used to fixedly secure relative positions of an electronic component within a computer case 60, wherein the electronic component fixing device 40 primarily comprises: the restraining piece 401 positioned in a horizontal direction to the electronic component, and at least one antiskid screw 402 positioned in a vertical direction to the electronic component, wherein the antiskid screws 402 enable reducing shaking or vibration of an electronic component when operating, thereby lowering noise produced therefrom. Taking a common power supply 50 of a general computer as an example, because a plurality of cooling fans are assembled within the power supply 50, thus, vibration or shaking is produced when operating. Moreover, when installing the power supply 50, a side of the power supply 50 is fixedly secured to a retaining wall 601 of the computer case 60, and the restraining piece 401 of the electronic component fixing device 40 of the present invention is assembled to the adjacent retaining wall 601 of the computer case 60 and is locked or restrained to a corresponding surface of the power supply 50, thereby enabling the power supply 50 to be stably secured between the restraining piece 401 and the retaining walls 601 so as to suppress horizontal vibration of the power supply 50 when operating. A plurality of partitions 602 are formed within the computer case 60, and one of the partitions 602 is mutually parallel with the aforementioned retaining wall 601 used to assemble the restraining piece 401, and the antiskid screws 402 of the electronic component fixing device 40 of the present invention are caused to movably penetrate the partition 602. After the antiskid screws 402 are locked tight to the partition 602, an antiskid sleeve 4023 of one end of each of the antiskid screws 402 vertically tightly abuts against the top surface of the power supply 50 so as to suppress vertical vibration when the power supply 50 is operating. After separately pressing and restraining the horizontal surface and the perpendicular surface of the power supply 50 by means of the electronic component fixing device 40 of the present invention, then vibration or shaking is completely suppressed when the power supply 50 is operating, thereby reducing noise produced by friction or impact between the power supply 50 and the computer case 60.

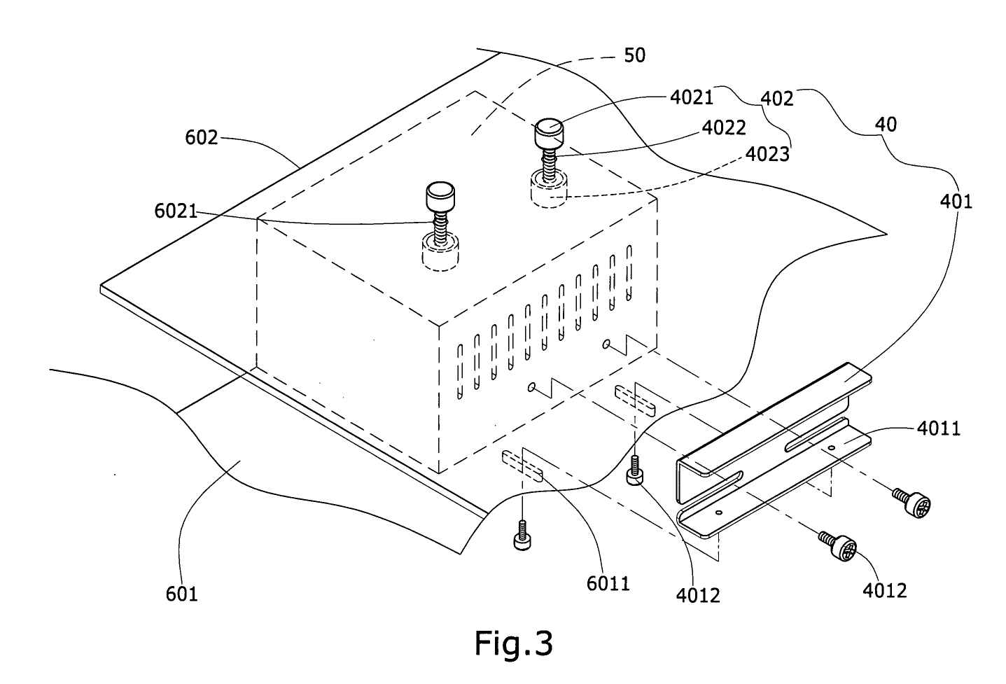

Referring to FIG. 3, which shows an exploded elevational view depicting the preferred embodiment of the present invention, and, as depicted in the drawing, the aforementioned electronic component fixing device 40 primarily comprises: The restraining piece 401, which is used to assemble to the retaining wall 601 parallel to the power supply 50 in a horizontal direction; moreover, a plurality of fixing portions 4011 are formed on the restraining piece 401, and after a plurality of fixing screws 4012 are used to penetrate the fixing portions 4011, then the restraining piece 401 is respectively fixedly secured to the retaining wall 601 and to the surface of the power supply 50, thus additionally horizontally fixing the power supply 50. Furthermore, a plurality of corresponding long through holes 6011 are formed in the retaining wall 601 to enable assembling the restraining piece 401 thereto, thereby enabling fine adjustment to a certain degree to be made in the direction the long through holes 6011 are defined when fixedly securing the restraining piece 401. Moreover, adjustment of distance can be carried out to accommodate different sizes of electronic components. The electronic component fixing device 40 further comprises the at least one antiskid screw 402, which is assembled to the partition 602 in a perpendicular direction relative to the power supply 50, wherein each of the antiskid screws 402 comprises a screw head portion 4021, a threaded portion 4022 and the antiskid sleeve 4023. Furthermore, a plurality of corresponding through holes 6021 are formed in the partition 602 to enable the antiskid screws 402 to be assembled to the partition 602. When adjustably tightening the screw head portion 4021 of the antiskid screw 402, the threaded portion 4022 is caused to move up and down within the through hole 6021, thereby enabling adjusting pressing of the antiskid sleeve 4023 on the perpendicular surface of the power supply 50 and tightness thereon at anytime. Furthermore, because the antiskid sleeve 4023 is fabricated from soft rubber material, thus, the antiskid sleeve 4023 is able to stably press down on the power supply 50 without causing damage thereto.

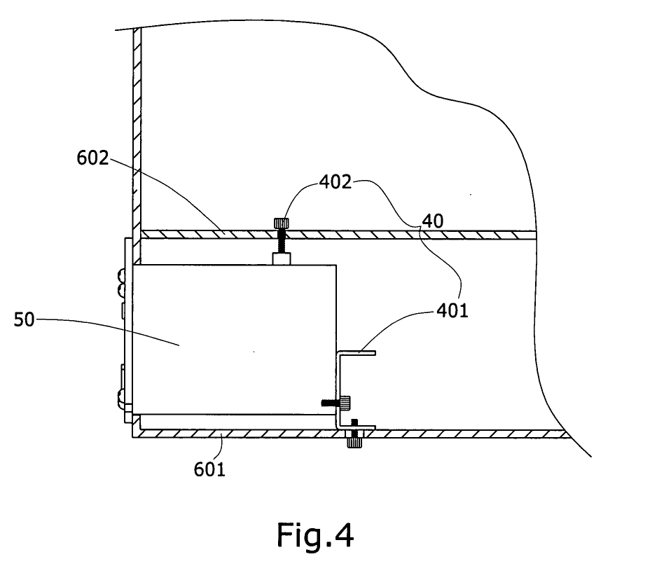

Referring to FIG. 4, which shows an assembled cutaway view of the preferred embodiment according to the present invention, and, as depicted in the drawing, the restraining piece 401 of the aforementioned electronic component fixing device 40 Is secured to the opposite side of the fixed surface of the power supply 50 and to the retaining wall 601 parallel to the power supply 50, thereby completely fixing the power supply 50 in a horizontal direction, and is able to completely suppress horizontal vibration or shaking of the power supply 50 when operating. Furthermore, the upper antiskid screws 402 are adjustably tightened in a perpendicular direction through the partition 602 parallel to the power supply 50, and the antiskid screws 402 tightly abut against the top surface of the power supply 50, thereby completely fixing the power supply 50 in a perpendicular direction. Accordingly, vertical vibration or shaking of the power supply 50 when operating is completely suppressed, and noise produced by friction or impact between the power supply 50 and the retaining wall 601 or the partition 602 is reduced.

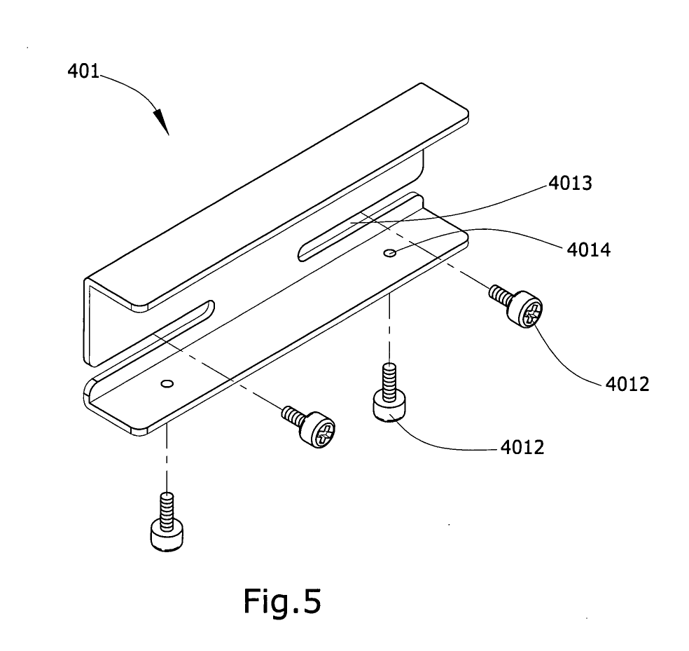

Referring to FIG. 5, which shows an elevational structural view depicting the restraining piece 401 n the preferred embodiment of the present invention, and, as depicted in the drawing, in order to further reduce the weight and lower manufacturing cost of the restraining piece 401, the restraining piece 401 is sheet metal formed or punch formed, whereby a piece of sheet metal is made to form a squared-off U-shape through successive bending thereof. Moreover, a plurality of locating holes 4013 are formed in one side of the restraining piece 401, and are used to enable the aforementioned fixing screws 4012 to penetrate the aforementioned long through holes 6011 of the aforementioned retaining wall 601, thereby enabling appropriate adjustment of the restraining piece 401 to correspond to the position of the electronic component and fixing the restraining piece 401 to the retaining wall 601, and thus facilitating accommodating various electronic components of different sizes. Furthermore, a plurality of fixing holes 4014 are formed in the center portion of the restraining piece 401 to enable the aforementioned fixing screws 4012 to penetrate therethrough and fix the restraining piece 401 to one side of the electronic component.

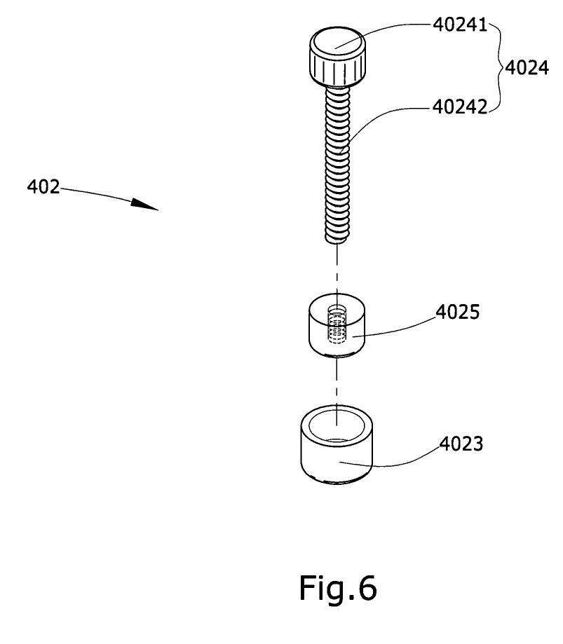

Referring to FIG. 6, which shows an elevational structural view depicting the antiskid screw 402 in the preferred embodiment of the present invention, and, as depicted in the drawing, the antiskid screw 402 is structured to comprise a screw 4024, a fixing piece 4025 and the antiskid sleeve 4023. Moreover, the screw 4024 is formed from a screw head portion 40241 and a screw rod 40242; the fixing piece 4025 is fixed to the end of the screw rod 40242, and the antiskid sleeve 4023 covers and is joined to the outer portion of the fixing piece 4025. When assembling the aforementioned partition 602, the screw rod 40242 of the screw 4024 is caused to movably penetrate the partition 602, after which the fixing piece 4025 together with the antiskid sleeve 4023 are fixed to the end of the screw rod 40242, and reciprocating rotation of the screw head portion 40241 of the screw 4024 causes reciprocating displacement of the fixing piece 4025 and the antiskid sleeve 4023.

According to what has been described above, during implementation of the present invention, when an electronic component is fixed to a retaining wall of a computer case, and the restraining piece 401 is assembled to the adjacent retaining wall 601, thereby horizontally restraining the electronic component and enabling the electronic component to be fixed between the restraining piece 401 and the retaining walls. Furthermore, the antiskid screws 402 movably penetrate the partition 602 positioned parallel to the aforementioned retaining wall 601 to perpendicularly restrain the electronic component, thereby providing the electronic component fixing device which assuredly achieves effectiveness to enable suppressing horizontal and vertical vibration of an electronic component, and which further achieves the objective of reducing noise produced by the electronic component.

In conclusion, the effectiveness of the electronic component fixing device of the present invention to provide industrial practicability, originality and advancement clearly comply with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An electronic component fixing device, used to fixedly secure the relative position of an electronic component to a computer case, comprising:
the restraining piece assembled to a retaining wall parallel to the electronic component in a horizontal direction, a plurality of fixing portions are formed on the restraining piece, and a plurality of fixing screws are used to penetrate the fixing portions, thereby respectively fixedly securing the restraining piece to the retaining wall and a surface of the electronic component; and
at least one antiskid screw assembled to a partition in a vertical direction to the electronic component, the antiskid screw comprises a screw head portion, a threaded portion and an antiskid sleeve, after tightening the antiskid screws, the antiskid sleeves are used to restrain the perpendicular surface of the electronic component.

2. The electronic component fixing device according to claim 1, wherein a plurality of locating holes are formed in one surface of the squared-off U-shaped restraining piece, and a plurality of fixing holes are formed in the center of the restraining piece.

3. The electronic component fixing device according to claim 2, wherein the restraining piece is formed and fabricated from sheet metal.

4. The electronic component fixing device according to claim 2, wherein the restraining piece is formed and fabricated by punch forming.

5. The electronic component fixing device according to claim 1, wherein a plurality of corresponding long through holes are formed in the retaining wall used to assemble the restraining piece.

6. The electronic component fixing device according to claim 1, wherein the antiskid sleeve is fabricated from soft rubber material.

7. The electronic component fixing device according to claim 1, wherein the antiskid screw is structured to comprise a screw, a fixing piece and an antiskid sleeve, moreover, the screw is formed from a screw head portion and a screw rod; the fixing piece is fixed to the end of the screw rod, and the antiskid sleeve covers and is joined to the outer portion of the fixing piece.

8. The electronic component fixing device according to claim 7, wherein the antiskid sleeve is fabricated from soft rubber material.

9. The electronic component fixing device according to claim 1, wherein a plurality of corresponding through holes are formed in the partition used to assemble the antiskid screws.
